(19) United States
(12) Patent Application Publication
(10) Pub. No.: US 2026/0150141 A1
(43) Pub. Date: May 28, 2026

(54) PRIMARY NODE LOAD-BASED MULTI-RADIO DUAL CONNECTIVITY (MRDC) BEARER TYPE CONVERSION

(71) Applicant: Rakuten Symphony, Inc., Tokyo (JP)

(72) Inventors: Gugan ILANGOVAN, Karnataka (IN); Raghul SUNDARAVARADHAN, Karnataka (IN); Hanumantappa KORACHARA MAREPPA, Karnataka (IN); Santhiyaku Jeevakumar ANTONYRAJ, Karnataka (IN)

(73) Assignee: Rakuten Symphony, Inc., Tokyo (JP)

(21) Appl. No.: 19/081,122

(22) Filed: Mar. 17, 2025

(30) Foreign Application Priority Data
Nov. 25, 2024 (IN) 202411091772

(51) Int. Cl. H04W 76/15; H04W 24/10; H04W 28/02

(52) U.S. Cl. CPC H04W 76/15; H04W 24/10; H04W 28/0268

(57) ABSTRACT

Disclosed herein are an apparatus and method for multi-radio dual connectivity (MRDC) bearer type conversion. The method includes transmitting, by a primary node, a plurality of input parameters to a Radio Access Network (RAN) Intelligent Controller (RIC) and optionally includes transmitting, by a secondary node, a plurality of input parameters to a RAN Intelligent Controller (RIC). Further, the method includes receiving a bearer conversion threshold percentage from the RIC to the primary node, converting a plurality of bearers of a plurality of User Equipments (UEs) to a plurality of Secondary Cell Group (SCG) bearers when the plurality of UEs connected to a cell associated with the plurality of bearers is below the bearer conversion threshold percentage, and converting the plurality of bearers of the plurality of UEs to split bearers when the UEs connected to the cell associated with the SCG bearers exceed the bearer conversion threshold percentage.

### CROSS REFERENCE TO RELATED APPLICATION(S)

This application claims priority based on India Patent Application No. 202411091772 filed Nov. 25, 2024, the entire disclosure of which is incorporated by reference herein.

### FIELD

The present disclosure relates to a primary node load-based Multi-Radio Dual Connectivity (MRDC) bearer type conversion.

### BACKGROUND

The information disclosed in this background section is only for an enhancement of understanding of the general background of the disclosure and should not be taken as an acknowledgment or any form of suggestion that this information forms the prior art already known to a person skilled in the art.

A bearer type is determined based on the configuration for each Quality of Service (QoS) Class Identifier (QCI). FIG. 1A illustrates the bearer type 100a, according to an existing technique. The bearer type 100a may include a Master Cell Group (MCG), a Secondary Cell Group (SCG), and a split bearer. Each bearer type may include a Control Plane (C-plane), a User Plane (U-plane), a Core Network (CN), a primary node or a master node 102, and a secondary Node 104. The primary node 102 may include but is not limited to, an eNodeB (eNB), a base station, and the like. The secondary node 104 may include but is not limited to, a Secondary gNodeB (SgNB), the gNB, a base station, and the like.

A significant challenge arises from the inefficient utilization of resources and suboptimal data throughput, particularly during an automatic conversion of bearer types during a secondary node addition procedure in the context of Dual Connectivity (DC) scenarios. The current methodology for configuring bearer types relies on predefined settings corresponding to each QCI in the primary node 102. For instance, during the secondary node addition procedure, a specific QCI bearer is configured to automatically transition into the SCG bearer. This automatic conversion can lead to underutilization of resources at the primary node 102 and may result in degraded throughput performance.

Following the conversion of bearers into SCG bearers, the data path of these bearers is transferred to the secondary node 104. Consequently, the resources of the eNB are rendered inactive, even when the primary node 102 possesses the capacity to efficiently manage certain bearers. This situation creates a disparity between resource allocation and actual resource utilization, resulting in the primary node 102 remaining underutilized. Moreover, when all bearers are designated as SCG bearers and the data path is managed by the secondary node 104, the overall throughput can become suboptimal, particularly under heavy load conditions at the SgNB. In such instances, the data throughput may have fallen short of the potential levels achievable had the bearers been processed by the primary node 102, which may still have available capacity and reduced operational load.

FIG. 1B and FIG. 1C illustrate an ENDC bearer conversion procedure 100b and 100c, according to an existing technique. The ENDC bearer conversion procedure 100b revolves around the inefficient utilization of resources in a dual connectivity setup, specifically between the primary node 102 i.e., eNB, and the secondary node 104 i.e., SgNB during the bearer conversion process. At step 105, the QCI bearer may be set up between the eNB 102 and the UE1 106a, representing the start of communication between the UE1 106a and a network via the eNB 102. At step 110, the eNB 102 configures B1 measurement for the secondary node addition to the UE1 106a. After performing the B1 measurement, at step 115, the UE1 106a sends a measurement report to the eNB 102 to assess whether the conditions are favorable for the secondary node such as the SgNB 104.

The QCI bearer is configured as SCG as per configuration in eNB 120. At step 125, the eNB 102 executes the secondary node addition procedure, and the QCI bearer for UE1 is fully admitted as an SCG bearer. This moves the handling of the bearer traffic primarily to the SgNB 104. Once the SCG bearer is admitted, at step 130, all data for the UE1 106a is routed through the SgNB 104, which offloads the eNB 102. This procedure is repeated for the UE2 106b and subsequently for the UEn 106n, with each UE undergoing the same sequence of steps 135, 140, 145, 150, 160, 165, 170a, 170b, 175, 180a, and 180b: the QCI bearer is configured and admitted as an SCG bearer, and data is transferred through the SgNB 104. The main issue arises when all QCI bearers are admitted as the SCG bearers, leading to an underutilization of eNB 102 resources. Although this procedure offloads traffic to the SgNB 104, it may result in an imbalance in load distribution. The eNB 102 remains underutilized, while the SgNB 104 may become overloaded with traffic, leading to reduced throughput for the UEs connected to the SgNB 104.

Therefore, it is desired to address the above-mentioned disadvantages or other shortcomings or at least provide a useful alternative to overcome the above-mentioned disadvantages.

### SUMMARY

Disclosed herein are apparatus and methods for primary node load-based Multi-Radio Dual Connectivity (MRDC) bearer type conversion.

Also disclosed herein is a method for converting a plurality of bearers to a plurality of Secondary Cell Group (SCG) bearers or a plurality of split bearers. The method includes transmitting, by a primary node, a plurality of input parameters to a Radio Access Network (RAN) Intelligent Controller (RIC). Further, the method includes receiving, at the primary node, a bearer conversion threshold percentage from the RIC. Furthermore, the method includes converting, by the primary node, a plurality of bearers of the plurality of UEs to a plurality of Secondary Cell Group (SCG) bearers. The conversion of these bearers takes place only when the plurality of UEs is connected to a cell. The cell associated with the plurality of bearers is below the bearer conversion threshold percentage. In addition, the method includes converting, by the primary node, the plurality of bearers of the plurality of UEs to a plurality of split bearers. The conversion happens when the plurality of UEs is connected to a cell. The cell associated with the plurality of SCG bearers exceeds the bearer conversion threshold percentage. The plurality of split bearers distributes data between the primary node and a secondary node.

Also disclosed herein is a method for transmitting a determined bearer conversion threshold percentage. The method includes receiving, at a Radio Access Network (RAN) Intelligent Controller (RIC), a plurality of input parameters from the primary node and optionally from secondary nodes. Further, the method includes determining, by the RIC, a bearer conversion threshold percentage based on the received plurality of input parameters. Furthermore, the method includes transmitting, by the RIC, the determined bearer conversion threshold percentage to the primary node.

Also disclosed herein is an apparatus for converting a plurality of bearers to a plurality of Secondary Cell Group (SCG) bearers or a plurality of split bearers. The apparatus is configured to transmit a plurality of input parameters to a Radio Access Network (RAN) Intelligent Controller (RIC). Further, the apparatus is configured to receive a bearer conversion threshold percentage from the RIC. Furthermore, the apparatus is configured to convert the plurality of bearers of a plurality of User Equipments (UEs) to the plurality of Secondary Cell Group (SCG) bearers. The conversion of these bearers takes place only when the plurality of UEs is connected to a cell. The cell associated with the plurality of bearers is below the bearer conversion threshold percentage. In addition, the apparatus is configured to convert the plurality of bearers of the plurality of UEs to a plurality of split bearers. The conversion happens when the plurality of UEs is connected to a cell. The cell associated with the plurality of SCG bearers exceeds the bearer conversion threshold percentage. The plurality of split bearers distributes data between the primary node and a secondary node.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1A illustrates a bearer type, according to an existing technique;

FIG. 1B and FIG. 1C illustrate an ENDC bearer conversion procedure, according to an existing technique;

FIG. 2 illustrates an example block diagram of a bearer conversion environment, in accordance with an embodiment of the present disclosure;

FIG. 3A, FIG. 3B, and FIG. 3C depict signalling diagrams for the bearer conversion threshold percentage determination based on the received information from a primary node and a secondary node, in accordance with an embodiment of the present disclosure;

FIG. 4A, and FIG. 4B depict signalling diagrams for the bearer conversion threshold percentage determination based on the received information from the primary node, in accordance with an embodiment of the present disclosure;

FIG. 5A and FIG. 5B depict signalling diagrams for the ENDC bearer conversion procedure, in accordance with an embodiment of the present disclosure;

FIG. 6 illustrates a flowchart depicting a method for updating a determined bearer conversion threshold percentage to the primary node, according to an embodiment of the present disclosure;

FIG. 7 illustrates a flowchart depicting a method for converting the plurality of bearers to the plurality of SCG bearers or the plurality of split bearers based on the received bearer conversion threshold percentage, according to an embodiment of the present disclosure;

FIG. 8 illustrates a flowchart depicting a method for transmitting the determined bearer conversion threshold percentage to the primary node, according to an embodiment of the present disclosure; and

FIG. 9 illustrates components of the system to determine bearer conversion threshold percentage, in accordance with an embodiment of the present disclosure.

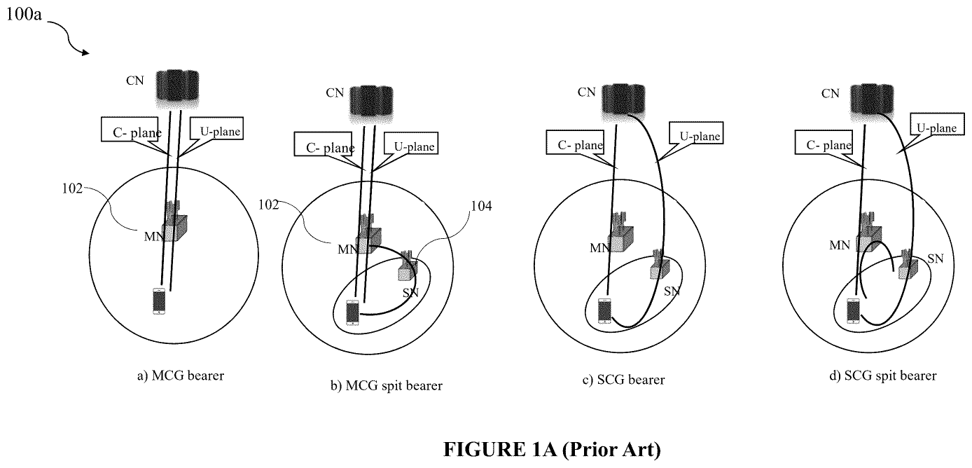

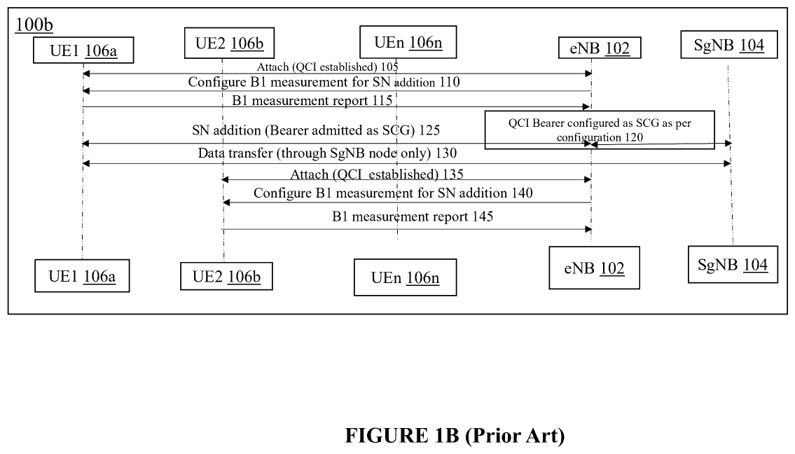

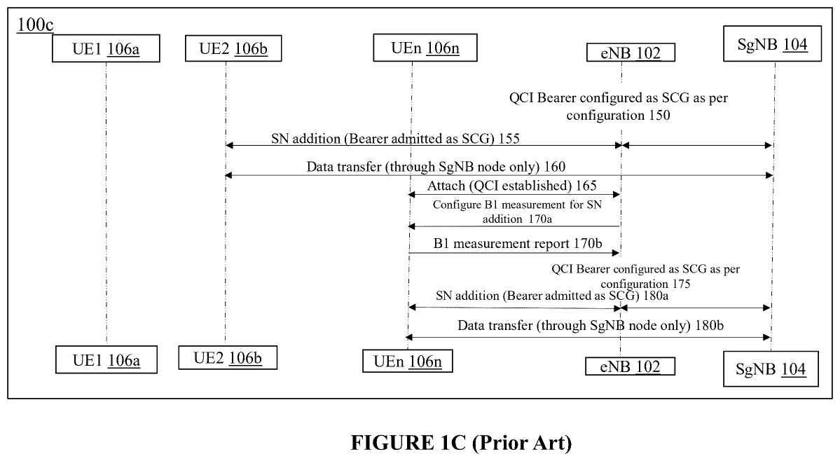

### DETAILED DESCRIPTION

The following detailed description of example embodiments refers to the accompanying drawings. The present disclosure provides illustrations and descriptions but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

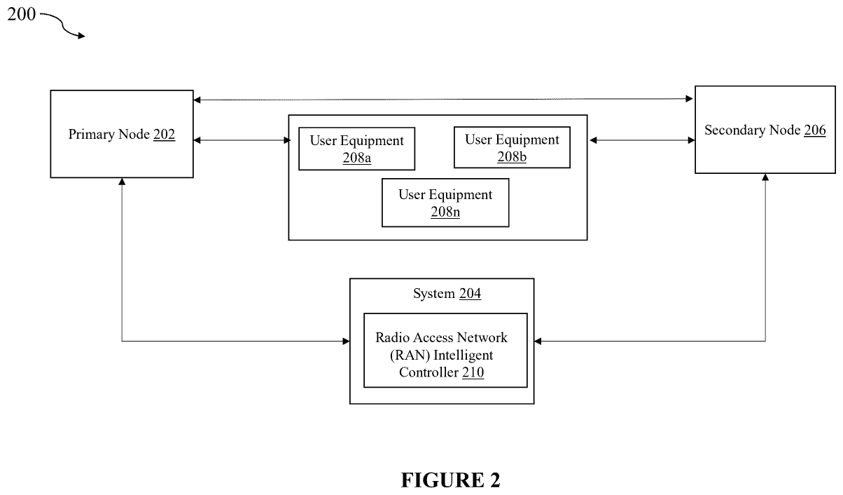

FIG. 2 illustrates an example block diagram 200 of a bearer conversion environment, in accordance with an embodiment of the present disclosure. The bearer conversion environment 200 may include a primary node 202, a system 204, a secondary node 206, and User equipment(s) 208a, 208b . . . 208n. The primary node 202 may include but is not limited to, an eNodeB (eNB), a base station, and the like. The secondary node 206 may include but is not limited to, a secondary gNodeB (gNB), a gNodeB (gNB), a base station, and the like. Further, the system 204 may include a Radio Access Network (RAN) Intelligent Controller (RIC) 210. In an embodiment, the primary node 202 may be associated with the system 204. The system 204 may be configured to perform bearer conversion based on a bearer conversion threshold percentage. The bearer conversion threshold percentage may indicate a predetermined limit of a plurality of UEs (208a, 208b . . . 208n) for regulating conversion of bearer types between the primary node 202 and the secondary node 206.

In an embodiment, the primary node 202 may be configured to transmit a plurality of input parameters to the RIC 210. The plurality of input parameters may include but is not limited to, a subscriber capacity, a cell bandwidth from configuration, the cell bandwidth of the secondary node 206, and the like. The cell bandwidth of the secondary node 206 may be received during a connection establishment of the primary node 202 with the secondary node 206 connection. The primary node 202 may be configured to receive the bearer conversion threshold percentage from the RIC 210.

In an embodiment, the RIC 210 may be configured to receive the plurality of input parameters from the primary node 202 and optionally from the secondary node 206. Further, the RIC 210 may be configured to determine the bearer conversion threshold percentage based on the received plurality of input parameters. Furthermore, the RIC 210 may be configured to transmit the determined bearer conversion threshold percentage to the primary node 202.

In an embodiment, the RIC 210 may be configured to wait for the plurality of input parameters from the primary node 202 upon determining that the plurality of input parameters is not available at the RIC 210. In another embodiment, the RIC 210 may be configured to establish a connection with the secondary node 206 and the primary node 202. The connection may be established upon determining that the plurality of input parameters is available from the primary node 202.

In an embodiment, the RIC 210 may be configured to receive the plurality of input parameters from the primary node 202 and optionally from the secondary node 206. In another embodiment, the RIC 210 may be configured to determine whether the plurality of input parameters is available from the secondary node 206. Further, the RIC 210 may be configured to wait for the plurality of input parameters from the secondary node 206 upon determining that the plurality of input parameters is not available at the RIC 210. The plurality of input parameters from the secondary node 206 may include a subscriber capacity, a plurality of User Plane (UP) instances, throughput statistics, the cell bandwidth, and the like. Furthermore, the RIC 210 may be configured to store the plurality of input parameters received from the primary node 202 and the secondary node 206. In addition, the RIC 210 may be configured to store the determined bearer conversion threshold percentage upon determining the bearer conversion threshold.

The RIC 210 may be configured to dynamically calculate the bearer conversion threshold percentage whenever the plurality of input parameters is updated from the primary node 202 or the secondary node 206. In an embodiment, while calculating the bearer conversion threshold percentage, the RIC 210 may use the information provided by the primary node 202 and the secondary node 206. In another embodiment, only the primary node 202 may be connected to the RIC 210. The secondary node 208 may belong to another vendor. So, there is no connection between the secondary node 208 and the RIC 210. While calculating the bearer conversion threshold percentage, the RIC 210 may use only the information provided by the primary node 202.

The bearer conversion threshold percentage is applicable for the bearer type conversion in Multi-Radio Dual Connectivity (MRDC) environment. The MRDC includes an Evolved-Universal Terrestrial Radio Access Network (E-UTRAN) New Radio (NR) Dual Connectivity (ENDC), an NR E-UTRA Dual Connectivity (NE-DC), EUTRAN DC and NR DC. The bearer conversion threshold percentage may be maintained per cell for regulating the bearer conversion.

In an embodiment, the primary node 202 may be configured to convert a plurality of bearers of the plurality of UEs (208a, 208b . . . 208x . . . 208n) to a plurality of Secondary Cell Group (SCG) bearers. The conversion of the plurality of bearers takes place only when the plurality of UEs (208a, 208b . . . 208x) is connected to a cell. The cell associated with the plurality of bearers may be below the bearer conversion threshold percentage. The primary node 202 may be configured to assign the plurality of bearers between the plurality of UEs (208a, 208b . . . 208n), and the secondary node 206 as the plurality of SCG bearers. The plurality of bearers may be assigned as part of the secondary node 206 addition. Further, data to the plurality of UEs (208a, 208b . . . 208x) is exclusively through the secondary node 206.

In another embodiment, the primary node 202 may be configured to convert the plurality of bearers of the plurality of UEs (208x+1 . . . 208n) to a plurality of split bearers. The conversion of the plurality of bearers takes place only when the plurality of UEs (208x+1 . . . 208n) is connected to the cell. The cell associated with the plurality of bearers may exceed the bearer conversion threshold percentage. The plurality of split bearers may distribute data between the primary node 202 and the secondary node 206. The primary node 202 may be configured to assign the plurality of bearers between the plurality of UEs (208x+1 . . . 208n), and the secondary node 206 as the plurality of split bearers. The plurality of bearers may be assigned as part of the secondary node 206 addition. Further, the data for the plurality of UEs (208x+1 . . . 208n) is through the primary node 202 and the Secondary node 206.

Since the primary node 202 is less loaded, the data draining rate may be higher. Thus, more throughput may be achieved for the plurality of UEs (208x+1 . . . 208n). Resources of the primary node 202 may be effectively utilized, while simultaneously reducing the load on the secondary node 206. In an example scenario, the plurality of UEs (208a, 208b . . . 208n) (for example, 700 UEs) connected to a network, with a Quality of Service (QoS) Class Identifier (QCI) configured as the plurality of SCG bearers. The predetermined threshold percentage for bearer conversion may be set at 80%. Initially, the plurality of UEs (208a, 208b . . . 208x) may be admitted with the default bearer, which is associated with the QCI. For the first 560 plurality of UEs (208a, 208b . . . 208x) (80% of the total connected UEs), the default bearer may be converted into the plurality of SCG bearers. During this phase, the primary node 202 may handle only the control plane signaling, with no significant load on resources. Once the bearer conversion threshold percentage is reached, the default bearer for the plurality of UEs (208x+1 . . . 208n) (for example, 140 UEs) is converted to the plurality of split bearers.

In In an embodiment, the secondary node 206 may include an O1 node refers to any RAN node, a subscriber manager (subscriber Mgr), and a commercial management agent framework (ConfD). The confD may be configured to push initial or dynamic configuration to the subscriber Mgr. The configuration push may involve transmitting critical configuration data, such as subscriber policies, thresholds, and service parameters, which may be necessary to optimize network performance and resource allocation. Further, the subscriber Mgr of the secondary node 206 may send the configuration update to the O1 node. Further, the O1 node may send a Remote Procedure Call (RPC) to a RAN Application (rAPP) to either create or merge the configuration data related to the secondary node information. The rAPP may store essential parameters, including maximum subscriber capacity (per cell), the number of UP instances (per CU-CP), cell bandwidth, and throughput statistics for the secondary node 206.

In an embodiment, the primary node 202 may include an O1 node refers to any RAN node, a subscriber manager (subscriber Mgr), and a commercial management agent framework (ConfD). The confD may be configured to push initial or dynamic configuration to the subscriber Mgr. The configuration push may involve transmitting critical configuration data, such as subscriber policies, thresholds, and service parameters, which may be necessary to optimize network performance and resource allocation. Further, the subscriber Mgr of the primary node 202 may send the configuration update to the O1 node. Further, the O1 node may send the RPC to the rAPP to either create or merge the configuration data related to the primary node information. The rAPP may store essential parameters, including maximum subscriber capacity (per cell), cell bandwidth, and cell bandwidth of neighbour SgNBs.

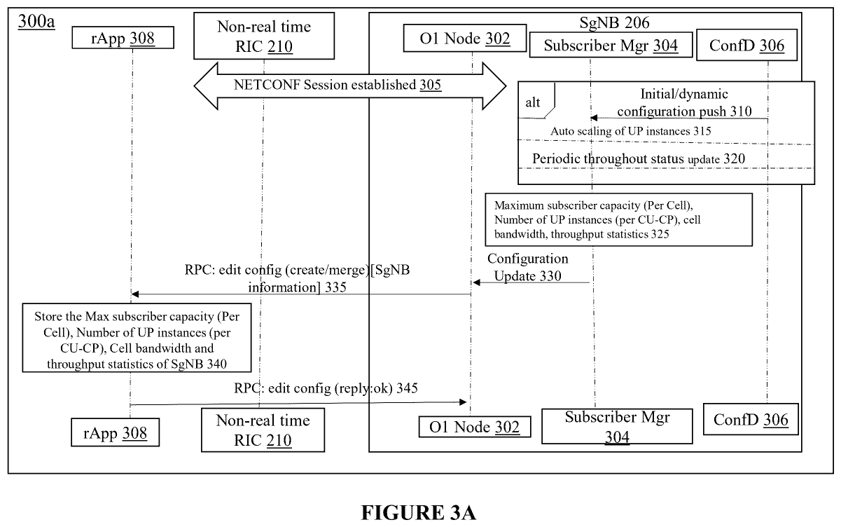

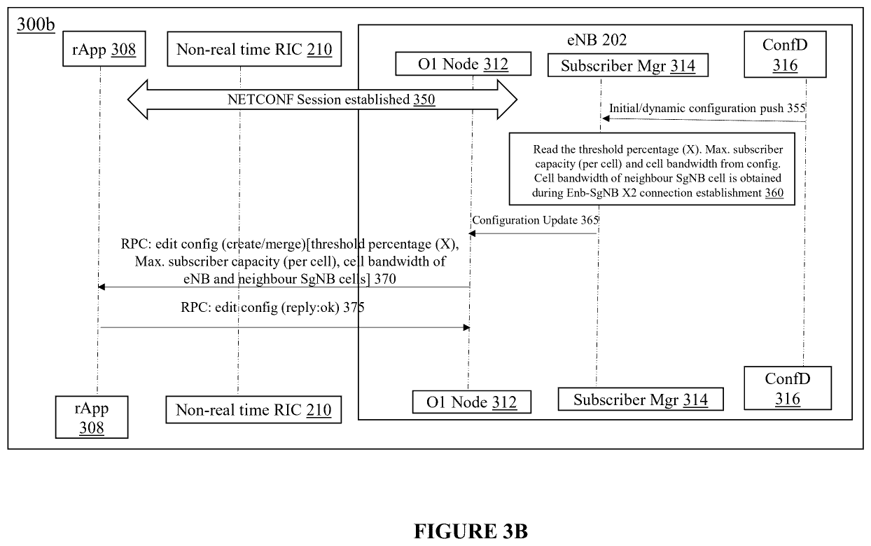

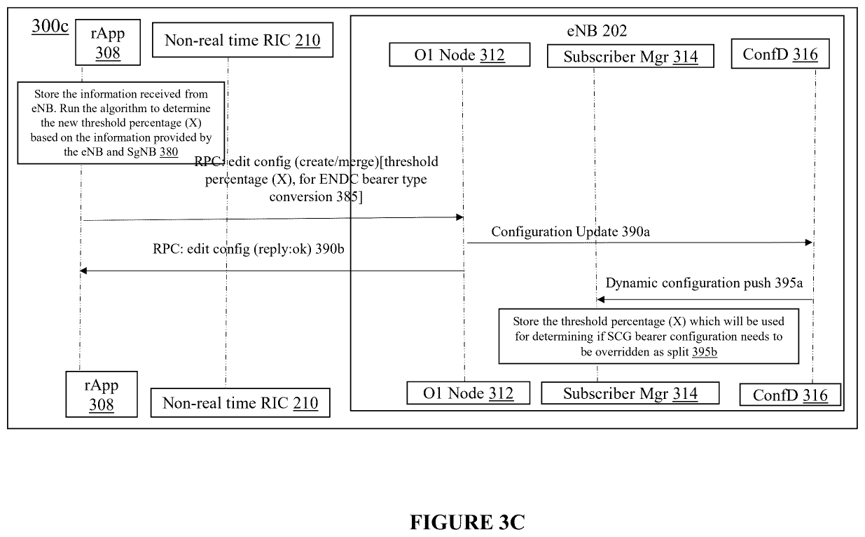

Reference is now made to FIG. 3A, FIG. 3B, and FIG. 3C depicting signaling diagrams 300a, 300b, and 300c for the bearer conversion threshold percentage determination based on the received information from the primary node 202 and the secondary node 206, in accordance with an embodiment of the present disclosure. The primary node 202 may include the eNB. The secondary node 206 may include the SgNB. The signaling diagram 300a may depict SgNB information update to the RIC 210. The signaling diagram 300b may depict eNB information update to the RIC 210. The RIC 210 may include a non-real-time RIC.

Initially, as seen in FIG. 3A, the SgNB 206 may include the O1 node 302 refers to any RAN node, the subscriber manager (subscriber Mgr) 304, and a commercial management agent framework (ConfD) 306. At step 305, a Network Configuration Protocol (NETCONF) session may be initiated between the RIC 210 and the O1 node 302. During this session, a secure communication channel may be established, enabling the exchange of configuration and operational data essential for network management. At step 310, an initial or dynamic configuration push from the ConfD 306 to the subscriber Mgr 304 may involve transmitting critical configuration data, such as subscriber policies, thresholds, and service parameters, which may be necessary to optimize network performance and resource allocation.

At step 315, the subscriber Mgr 304 may dynamically adjust the number of User Plane (UP) instances based on the current network load or demand. When traffic increases, additional UP instances may be created to accommodate the higher demand. Conversely, when traffic decreases, the subscriber Mgr 304 may scale down excess UP instances, ensuring that resource utilization remains efficient and aligned with current network conditions.

At step 320, the subscriber Mgr 304 may provide regular updates regarding throughput metrics. These updates may include performance indicators such as data transfer rates, bandwidth utilization, and network congestion levels. Such information may be utilized to monitor the overall health of the network and to identify opportunities for optimization, thereby enhancing the quality of service provided to subscribers.

At step 325, the subscriber Mgr 304 may generate a comprehensive set of input parameters. The comprehensive set may include maximum subscriber capacity (per cell), the number of UP instances (per CU-CP), cell bandwidth, throughput statistics, and other relevant metrics that may influence network performance and subscriber experience.

At step 330, the subscriber Mgr 304 may send a configuration update to the O1 node 302. The configuration update may contain critical information that ensures the O1 node 302 is aligned with the current operational requirements of the network.

At step 335, the O1 node 302 may send a Remote Procedure Call (RPC) to a RAN Application (rAPP) 308 to either create or merge the configuration data related to the SgNB information. Following this, at step 340, the rAPP 308 may store essential parameters, including maximum subscriber capacity (per cell), the number of UP instances (per CU-CP), cell bandwidth, and throughput statistics for the SgNB 206. After the rAPP 308 processes the configuration request (create/merge) concerning the SgNB information, which may send an acknowledgment reply of “OK” to the O1 node 302 at step 345. This acknowledgment may signify that the requested configuration update has been successfully received and applied by the rAPP 308, thereby allowing the O1 node 302 to proceed with further network management actions.

As seen in FIG. 3B, at step 350, the NETCONF session may be established between the RIC 210 and the O1 node 302. During this session, a secure communication channel may be established, allowing for the exchange of configuration and operational data. At step 355, initial or dynamic configuration push from the ConfD 316 to the subscriber Mgr 314 may involve sending the relevant configuration data, such as the subscriber policies, the thresholds, and the service parameters, from the ConfD 316 to the subscriberMgr 314. At step 360, the subscriber Mgr 314 may read the threshold percentage (X), the maximum subscriber capacity (per cell), and cell bandwidth from configuration, and obtain the cell bandwidth of neighbour SgNB during Enb-SgNB X2 connection establishment.

At step 365, the subscriber Mgr 314 of the eNB 202 may send the configuration update to the O1 node 312. At step 370, the O1 node 312 may send the RPC to the rAPP 308 to either create or merge the configuration data related to the eNB and SgNB information. At step 370, the rAPP 308 may store the maximum subscriber capacity (per cell), the cell bandwidth of the eNB, and neighbour SgNBs. After the rAPP 308 processes the configuration request (create/merge) related to the eNB information, at step 375, the rAPP 308 may send an acknowledgment reply “OK” to the O1 node 312. This indicates that the requested configuration update has been successfully received and applied by the rAPP, and the O1 node may proceed with further network management actions.

At step 375, the O1 node 312 may send the RPC command from the O1 node 312 to edit the network configuration. Edit the network configuration may include creating or merging specific configuration data, which includes, threshold percentage, maximum subscriber capacity (per cell), the cell bandwidth of the eNB, and neighbour SgNB cells. After the rAPP 308 processes the configuration request (create/merge) related to the eNB information, at step 375, the rAPP 308 may send an acknowledgment reply “OK” to the O1 node 312.

As seen in FIG. 3C, at step 380, the rAPP 308 may store the information received from eNB 202. The rAPP 308 may determine the new threshold percentage (X) based on the information provided by the eNB 202 and the SgNB 206.

At step 385, the rAPP 308 may send the RPC: edit-config command to the O1 node 312 to update or merge network parameters. Specifically, the edit-config command is focused on the threshold percentage (X) used for ENDC bearer type conversion. At step 390a, the O1 node 312 may send the configuration update to the confD 316. At step 390b, the O1 node 312 may send an acknowledgment reply “OK” to the rAPP 308. At step 395a, the ConfD 316 may push updated configuration parameters to the SubscriberMgr 314. After pushing the updated configuration parameters, at step 395b, the SubscriberMgr 314 may store the threshold percentage. The threshold percentage may be used for determining if the SCG bearer configuration needs to be overridden as a split.

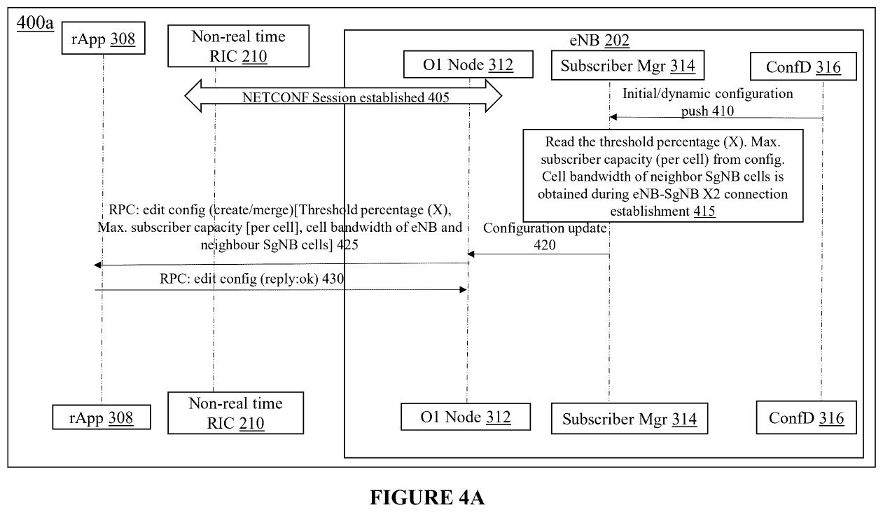

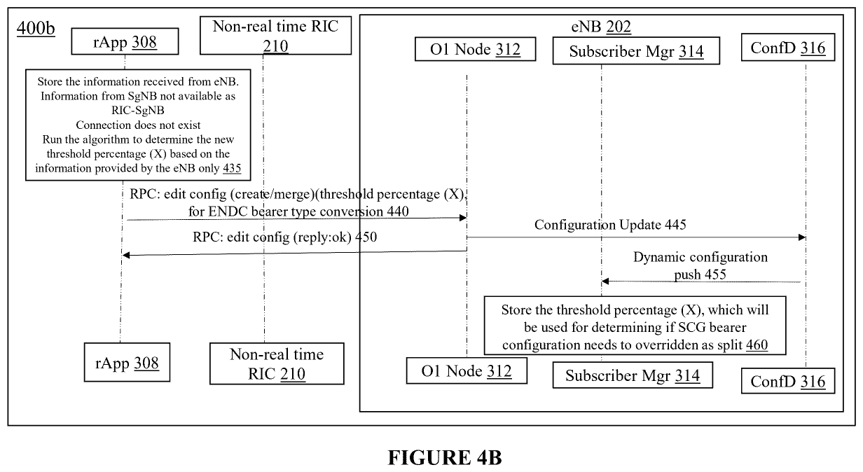

Reference is now made to FIG. 4A and FIG. 4B depict signaling diagrams 400a, and 400b for the bearer conversion threshold percentage determination based on the received information from the primary node 202, in accordance with an embodiment of the present disclosure. The primary node 202 may include the eNB. The signaling diagrams 400a and 400b may depict eNB information updates to the RIC 210.

As seen in FIG. 4A, at step 405, the NETCONF session may be established between the RIC 210 and the O1 node 312. At step 410, initial or dynamic configuration push from the ConfD 316 to the subscriber Mgr 314 may involve sending the relevant configuration data, such as the subscriber policies, the thresholds, and the service parameters, from the ConfD 316 to the subscriberMgr 314.

At step 415, the subscriberMgr 314 may read the threshold percentage (X). Maximum subscriber capacity (per cell) from configuration and the cell bandwidth of the eNB and the neighbour SgNB cells may be obtained during eNB-SgNB X2 connection establishment.

At step 420, the subscriber Mgr 314 of the eNB 202 may send the configuration update to the O1 node 312. After receiving the configuration update at the O1 node 312, at step 425, the O1 node 312 may send the RPC: edit-config command to the rAPP 308 to update or merge network parameters. Specifically, the edit-config command may be focused on the threshold percentage (X), maximum subscriber capacity [per cell], and the cell bandwidth of the eNB 202 and the neighbour SgNB cells. At step 430, the rAPP 308 may send an acknowledgment reply “OK” to the O1 node 312.

At step 435, the rAPP 308 may store the information received from the eNB 402. Information from the SgNB may be not available as the RIC-SgNB connection may not exist. The rAPP 308 may run the system 204 to determine the new threshold percentage (X) based on the information provided by the eNB 202 only.

At step 440, the rAPP 308 may send the RPC: edit-config command to the O1 node 312 to update or merge network parameters. Specifically, the edit-config command is focused on the threshold percentage (X) used for ENDC bearer type conversion. At step 445, the O1 node 312 of the eNB 202 may send the configuration update to the confD 316. At step 450, the rAPP 308 may receive the acknowledgment reply “OK” from the O1 node 312. At step 455, the ConfD 316 may push updated configuration parameters to the SubscriberMgr 314.

At step 460, the SubscriberMgr 314 may store the threshold percentage (X), which may be used for determining if the SCG bearer configuration needs to be overridden as split.

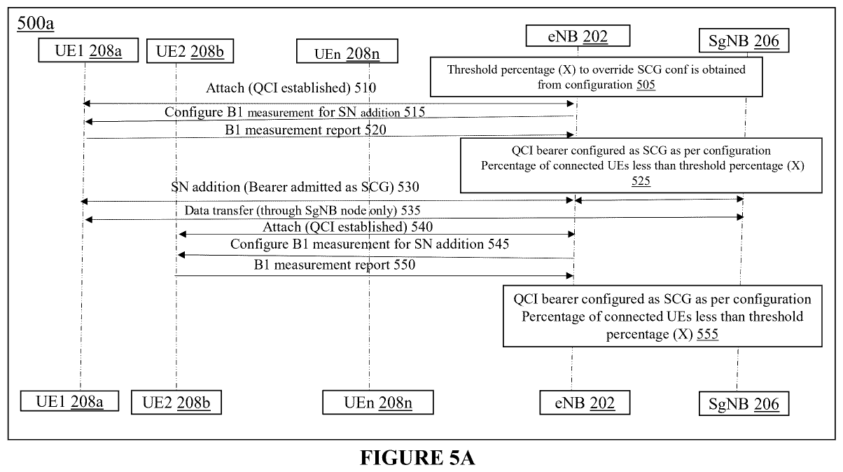

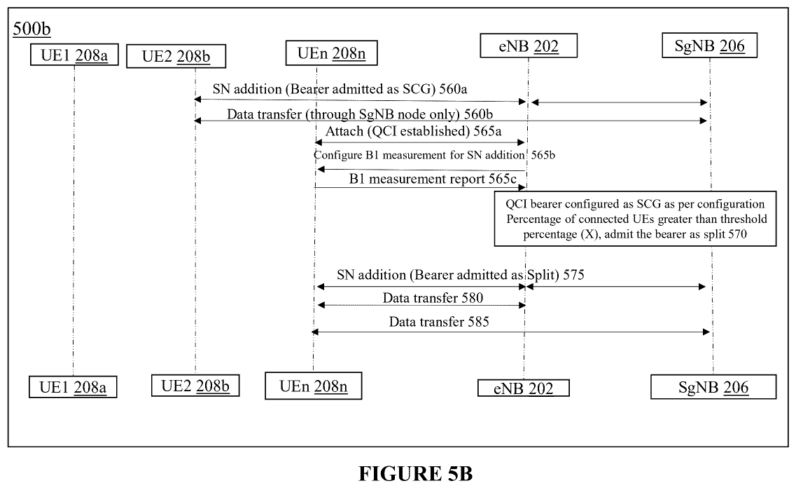

Reference is now made to FIG. 5A and FIG. 5B depict signaling diagrams 500a, and 500b for the ENDC bearer conversion procedure, in accordance with an embodiment of the present disclosure. The primary node 202 may include the eNB. The secondary node 206 may include the SgNB. The ENDC bearer conversion procedure 500a and 500b revolves around utilization of resources in a dual connectivity setup, specifically between the primary node 202 i.e., eNB, and the secondary node 206 i.e., the SgNB during the bearer conversion process.

As seen in FIG. 5A, at step 505, the threshold percentage (X) may be obtained from the configuration to override the default SCG bearer configuration. The threshold percentage may dictate when the system overrides the default SCG configuration based on network conditions, such as the load on the eNB 202 and the SgNB 206 and available resources, ensuring optimal network performance.

At step 510, the QCI bearer may be set up between the eNB 202 and the UE1 208a, representing the start of communication between the UE1 208a and a network via the eNB 202. At step 515, the eNB 202 may configure B1 measurement for the secondary node addition to the UE1 208a. The eNB 202 may enable the UE1 208a to assess the surrounding network conditions, specifically the secondary node such as the SgNB 206. After performing the B1 measurement, at step 520, the UE1 208a may send a measurement report to the eNB 202 to assess whether the conditions are favorable for the secondary node such as the SgNB 206.

Once the conditions are met, at step 525, the QCI bearer may be configured as an SCG bearer as per the configuration as the percentage of connected UEs may be less than the threshold percentage (X).

At step 530, the eNB 202 may execute the secondary node addition procedure, and the QCI bearer for UE1 is fully admitted as the SCG bearer. This moves the handling of the bearer traffic primarily to the SgNB 206. Once the SCG bearer is admitted, at step 535, all data for the UE1 208a may be routed exclusively through the SgNB 206.

At step 540, the QCI bearer may be set up between the eNB 202 and the UE2 208b. At step 545, the eNB 202 may configure the B1 measurement for the secondary node addition to the UE2 208b. The eNB 202 may enable the UE2 208b to assess the surrounding network conditions, specifically the secondary node such as the SgNB 206. After performing the B1 measurement, at step 550, the UE2 208b may send the measurement report to the eNB 202 to assess whether the conditions are favorable for the secondary node such as the SgNB 206.

The QCI bearer may be configured as SCG as per configuration. Once the conditions are met, at step 555, the QCI bearer may be configured as the SCG bearer as per the configuration and the percentage of connected UEs may be less than the threshold percentage (X).

As seen in FIG. 5B, at step 560a, the eNB 202 may execute the secondary node addition procedure, and the QCI bearer for the UE2 208b is fully admitted as the SCG bearer. Once the SCG bearer is admitted, At step 560b, all data for the UE2 208b may be routed exclusively through the SgNB 206.

At step 565a, the QCI bearer may be set up between the eNB 202 and the UEn 208n. At step 565b, the eNB 202 may configure the B1 measurement for the secondary node addition to the UEn 208n. The eNB 202 may enable the UEn 208n to assess the surrounding network conditions, specifically the secondary node such as the SgNB 206. After performing the B1 measurement, at step 565c, the UEn 208n may send the measurement report to the eNB 202 to assess whether the conditions are favorable for the secondary node such as the SgNB 206.

Once the conditions are met, at step 570, the QCI bearer may be configured as the SCG bearer as per the configuration. If the percentage of connected UEs (208a, 208b . . . 208n) is greater than the threshold percentage (x), the bearer may be admitted as the split bearer. At step 575, the eNB 202 may execute the secondary node addition procedure, and the QCI bearer for the UEn 208n is admitted as the split bearer. As a result, at step 580, part of data for the UEn 208n may be routed through the eNB 202. Further, at step 585, part of data for the UEn 208n may be routed through the SgNB 206.

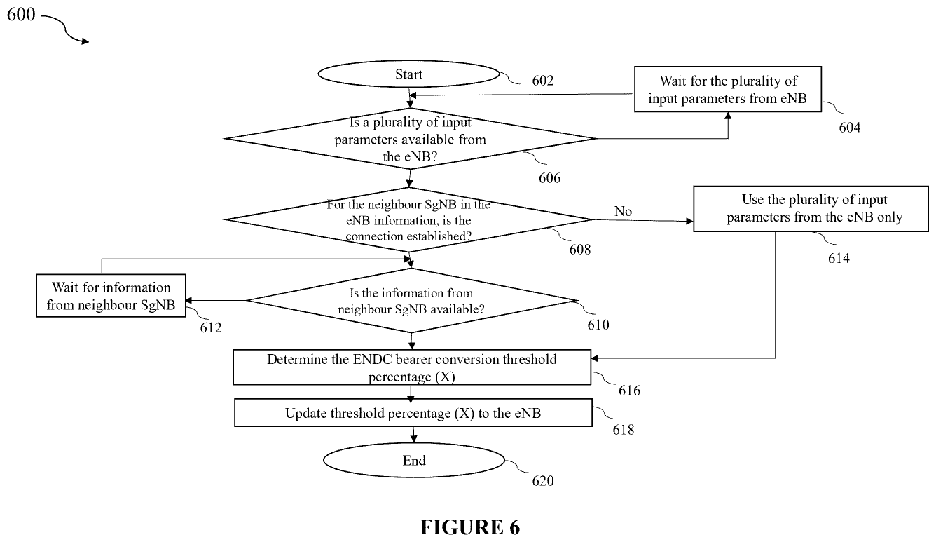

FIG. 6 illustrates a flowchart depicting a method 600 for updating the determined bearer conversion threshold percentage to the primary node 202, according to an embodiment of the present disclosure. In an embodiment of the present disclosure, the method 600 may be performed by the RIC 210, as explained concerning FIG. 2. For the sake of brevity, technical implementations as explained in FIG. 2 and FIG. 3A-5C are omitted herein.

At step 602, the method 600 may include initiating the method by the RIC 210 for transmitting the determined bearer conversion threshold percentage.

At step 604, the method 600 may include determining whether the plurality of input parameters is available from the RIC 210. If the plurality of input parameters is not available, at step 606, the method 600 may include waiting for the eNB information.

If the plurality of input parameters is available, at step 608, the method 600 may include determining by the RIC 210 whether the connection from the RIC 210 with the neighbor secondary node 206 is established. If the connection is established, at step 610, the method 600 may include determining by the RIC 210 whether the plurality of input parameters from the secondary node 206 is available at the RIC 210. If the plurality of input parameters is not available from the secondary node 206, at step 612, the method 600 may include waiting for the plurality of input parameters from the secondary node 206.

If the connection is not established between the secondary node 206 with and RIC, at step 614, the method 600 may use the plurality of input parameters from the primary node 202 only. With the plurality of input parameters from 610 or 614, at step 616, the method 600 may include determining the ENDC bearer conversion threshold percentage (X). At step 618, the method 600 may include updating the determined bearer conversion threshold percentage to the primary node 202. At step 620, the method 600 may end.

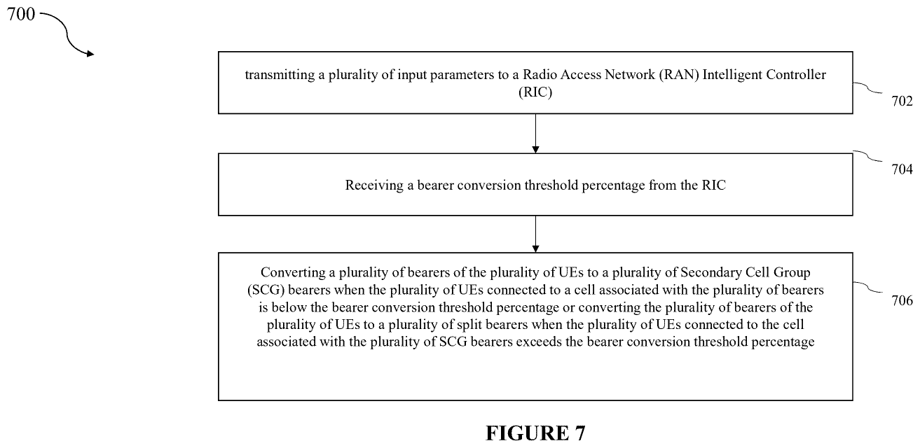

FIG. 7 illustrates a flowchart depicting a method 700 for converting the plurality of bearers to the plurality of SCG bearers or the plurality of split bearers based on the received bearer conversion threshold percentage, according to an embodiment of the present disclosure. In an embodiment of the present disclosure, the method 700 may be performed by the primary node 202, as explained concerning FIG. 2. For the sake of brevity, technical implementations as explained in FIG. 2 and FIG. 3A-5C are omitted herein.

At step 702, the method 700 may include transmitting, by the primary node 202 and secondary node, the plurality of input parameters to the RIC 210.

At step 704, the method 700 may include receiving, by the primary node 202, the bearer conversion threshold percentage from the RIC 210.

At step 706, the method 700 may include performing one of these based on the received bearer conversion threshold percentage, converting, by the primary node 202, the plurality of bearers of the plurality of UEs (208a, 208b . . . 208n) to the SCG bearers when the plurality of UEs (208a, 208b . . . 208n) are connected to the cell. The cell associated with the plurality of bearers may be below the bearer conversion threshold percentage, or converting the plurality of bearers of the plurality of UEs (208a, 208b . . . 208n) to the plurality of split bearers when the plurality of UEs (208a, 208b . . . 208n) connected to the cell associated with the plurality of SCG bearers exceeds the bearer conversion threshold percentage. The plurality of split bearers may distribute data between the primary node 202 and the secondary node 206.

The method 700 may include the bearer conversion threshold percentage that includes the MRDC. The MRDC may include but is not limited to, the ENDC bearer conversion threshold percentage, a New Radio Dual Connectivity (NR-DC) bearer conversion threshold percentage, and an NR E-UTRA Dual Connectivity (NE-DC) bearer conversion threshold percentage, and the like. The bearer conversion threshold percentage may indicate the predetermined limit of the plurality of UEs (208a, 208b . . . 208n) for regulating the conversion of bearer types between the primary node 202 and the secondary node 206. Further, the method 700 may include the plurality of input parameters received from the primary node 202. The plurality of input parameters may be optionally received from the secondary node 206. The plurality of input parameters may include the subscriber capacity, the cell bandwidth from configuration, and the cell bandwidth of the secondary node 206 from the primary node 202. The cell bandwidth of the secondary node 206 may be received during the connection establishment of the primary node 202 with the secondary node 206 connection. The plurality of input parameters may include maximum subscriber capacity (per cell), the number of UP instances (per CU-CP), cell bandwidth, and throughput statistics from the secondary node 206

The method 700 may include establishing, by the primary node 202, the QCI between the plurality of UEs (208a, 208b . . . 208n), and the primary node 202. Further, the method 700 may include configuring, from the primary node 202, the signal measurement for the secondary node addition to the plurality of UEs (208a, 208b . . . 208n) upon establishing the QCI. Furthermore, the method 700 may include receiving, at the primary node 202, the signal measurement report from the plurality of UEs (208a, 208b . . . 208n) based on configuration.

The method 700 may include assigning, by the primary node 202, as part of the secondary node (SN) addition, the plurality of bearers between the plurality of UEs (208a, 208b . . . 208n) and the secondary node 206 as the plurality of SCG bearers. Further, the method 700 may include transferring, the data to the plurality of UEs (208a, 208b . . . 208n) exclusively through the secondary node 206 upon assigning the plurality of bearers as the plurality of SCG bearers.

The method 700 may include assigning, by the primary node 202, as part of the secondary node addition, the plurality of bearers between the plurality of UEs (208a, 208b . . . 208n) and the secondary node 206 as the plurality of split bearers. Further, the method 700 may include transferring, through the primary node 202 and the secondary node 206, the data to the plurality of UEs (208a, 208b . . . 208n) upon assigning the plurality of bearers as the plurality of split bearers.

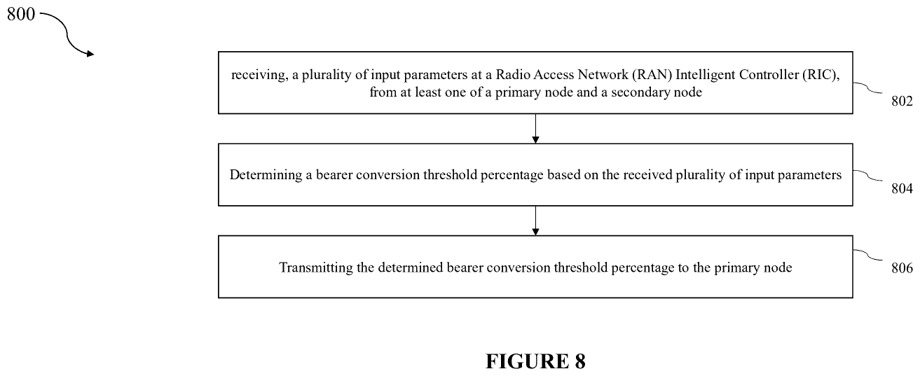

FIG. 8 illustrates a flowchart depicting a method 800 for transmitting the determined bearer conversion threshold percentage to the primary node, according to an embodiment of the present disclosure. In an embodiment of the present disclosure, the method 800 may be performed by the RIC 210, as explained concerning FIG. 2. For the sake of brevity, technical implementations as explained in FIG. 2 and FIG. 3A-5C are omitted herein.

At step 802, the method 800 may include receiving, at the RIC 210, the plurality of input parameters from the primary node 202 and the secondary node 206.

At step 804, the method 800 may include determining, by the RIC 210, the bearer conversion threshold percentage based on the received plurality of input parameters.

At step 806, the method 800 may include transmitting, by the RIC 210, the determined bearer conversion threshold percentage to the primary node 202.

The method 800 may include determining, by the RIC 210, whether the plurality of input parameters from primary node 202 is available at the RIC 210. The method 800 may include performing, by the RIC 210, one of waiting for the plurality of input parameters from the primary node 202 upon determining that the plurality of input parameters from the primary node 202 is not available at the RIC 210. Further, the method 800 may include determining, by the RIC 210, whether the establishment of the connection with the secondary node 206 with the RIC 210 is available upon determining that the plurality of input parameters from the primary node 202 is available at the RIC 210. Furthermore, the method 800 may include performing, by the RIC 210, receiving the plurality of input parameters from the primary node 202 upon determining that a non-establishment of the connection with the secondary node 206 with the RIC 210. In addition, the method 800 may include determining, by the RIC 210, whether the plurality of input parameters is available from the secondary node 206. Further, the method 800 may include waiting for the plurality of input parameters from the secondary node 206 upon determining that the plurality of input parameters from the secondary node 206 is not available at RIC 210. Furthermore, the method 800 may include storing, by the RIC 210, the plurality of input parameters received from the primary node 202 and optionally from the secondary node 206. In addition, the method 800 may include storing, by the RIC 210, the determined bearer conversion threshold percentage upon determining the bearer conversion threshold.

The method 800 may include the plurality of input parameters from the primary node 202. The plurality of input parameters may include the subscriber capacity, the cell bandwidth from configuration, and the cell bandwidth of the secondary node. The cell bandwidth of the secondary node 206 may be received during the connection establishment of the primary node 202 with the secondary node 206. Further, the method 800 may include the plurality of input parameters from the secondary node 206. The plurality of input parameters may include the subscriber capacity, the plurality of User Plane (UP) instances, throughput statistics, and the cell bandwidth. The method 800 may include the bearer conversion threshold percentage that includes the ENDC bearer conversion threshold percentage. The bearer conversion threshold percentage may indicate a predetermined limit of the plurality of UEs for regulating the conversion of bearer types between the primary node 202 and the secondary node 206.

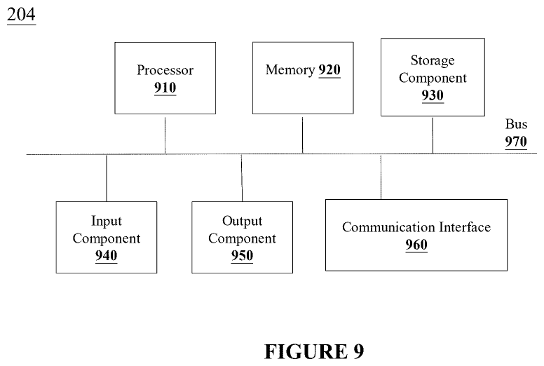

FIG. 9 illustrates an embodiment of the system 204 connected to the primary node 202 and the secondary node 206. The example components of the system 204 are configured to convert the plurality of bearers of the plurality of UEs to the plurality of SCG bearers when the plurality of UEs connected to the cell associated with the plurality of bearers is below the bearer conversion threshold percentage. Alternatively, example components of the system 204 may be configured to convert the plurality of bearers of the plurality of UEs to the plurality of split bearers when the plurality of UEs connected to the cell associated with the plurality of SCG bearers exceeds the bearer conversion threshold percentage. Further, the system 204 may be configured to transmit the determined bearer conversion threshold percentage to the primary node 202. The system 204 discussed here corresponds to an apparatus. As shown in FIG. 9, the system 204 includes processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single-core processor, or a combination of one or more multi-core processors and/or one or more single-core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer-readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

The storage component 930 stores information and/or software related to the operation and use of the device 900. For example, the storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touchscreen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the system 204. For example, the output component 950 may be, but not limited to, a display, a speaker, an instruction device to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the system 204 and other devices. In other words, the standard of the communication interface 960 is not limited.

The bus 970 acts as an interconnect between the processor 910, the memory 920, the storage component 930, the input component 940, the output component 950, and the communication interface 960 of the system 204. The bus 970 may include a wired interconnection or a wireless interconnection.

The number and arrangement of components shown in FIG. 9 are provided as an example. In practice, system 204 may include additional components, fewer components, different components, or differently arranged components than those shown in FIG. 9. Additionally, or alternatively, a set of components (e.g., one or more components) of system 204 may perform one or more functions described as being performed by another set of components of system 204. Further, one or more method steps described in any of the embodiments may be performed utilizing a plurality of systems 900 in communication with one another.

In an embodiment, the system 204 may include the processor 910 and the memory 920 configured to perform the functions as described in the present disclosure. The memory 920 may include executable instructions that, when executed by the processor 910, cause the system 204 to perform the functions as described in the present disclosure. As an example, the processor 910 may be a single processing unit or a number of units, all of which could include multiple computing units. The processor 910 may be implemented as one or more microprocessors, microcomputers, microcontrollers, digital signal processors, central processing units, state machines, logic circuitries, and/or any devices that manipulate signals based on operational instructions. Among other capabilities, the processor 910 is configured to fetch and execute computer-readable instructions and data stored in the memory 920. The processor 910 may include one or a plurality of processors.

The memory 920 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. In an embodiment, the system 204 may be implemented as dedicated hardware units. In another embodiment, the system 204 may be implemented in the form of virtualized software units in hardware or cloud environments.

Further, the processor 910 may be configured to receive the plurality of input parameters from at least one of the primary node 202 and the secondary node 206. Furthermore, the processor 910 may be configured to determine the bearer conversion threshold percentage based on the received plurality of input parameters. In addition, the processor 910 may be configured to transmit the determined bearer conversion threshold percentage to the primary node 202 or the secondary node 206.

The present disclosure provides the apparatus and method for primary node load-based Multi-Radio Dual Connectivity (MRDC) bearer type conversion. The apparatus dynamically converts the plurality of bearers between the SCG and split configurations based on the plurality of connected UEs, the present disclosure ensures efficient use of eNB resources, avoiding underutilization when the eNB can support data transfer. For the plurality of UEs that exceed the threshold, the plurality of bearers are split between the eNB and the SgNB, which helps balance the data load and increases overall throughput, particularly when the SgNB experiences heavy load conditions. The apparatus uses the plurality of SCG bearers only when the plurality of connected UEs is below the threshold, the apparatus reduces the excessive load on the SgNB, ensuring better performance and preventing bottlenecks during high-traffic periods. The apparatus provides a flexible mechanism that adapts bearer configurations in real-time based on network conditions, enhancing overall system performance and maintaining a balance between the eNB and the SgNB.

The apparatus intelligently distributes data traffic and dynamically adjusts bearer configurations, the apparatus improves data transfer rates, reducing latency and ensuring a smoother user experience, especially in high-demand environments. The apparatus can potentially lower energy consumption by distributing the traffic load more effectively between the eNB and the SgNB, reducing the power requirements for heavy-loaded nodes.

Further, the present disclosure also describes non-transitory computer program products (i.e., physically embodies computer program products) or non-transitory computer-readable mediums encoded with executable instructions that store instructions. The executable instructions, when executed by one or more processors, such as the processors 910, cause the one or more processors to perform a method for the primary node load-based Multi-Radio Dual Connectivity (MRDC) bearer type conversion described in the present disclosure, as elaborated in above paragraphs. Examples of computer-readable mediums include non-volatile, hard-coded type mediums such as read-only memories (ROMs) or erasable, electrically programmable read-only memories (EEPROMs), and user-recordable type mediums such as floppy disks, hard disk drives and compact disk read-only memories (CD-ROMs) or digital versatile disks (DVDs).

Examples of the techniques and apparatus described herein include, but are not limited to, the following enumerated embodiments:
[1]. A method 700 comprising:
   transmitting, by a primary node 202, a plurality of input parameters to a Radio Access Network (RAN) Intelligent Controller (RIC) 210;
   receiving, by the primary node 202, a bearer conversion threshold percentage from the RIC 210;
   performing one of based on the received bearer conversion threshold percentage,
   converting, by the primary node 202, a plurality of bearers of a plurality of User Equipments (UEs) 208a, 208b . . . 208n to a plurality of Secondary Cell Group (SCG) bearers when the plurality of UEs 208a, 208b . . . 208n connected to a cell associated with the plurality of bearers is below the bearer conversion threshold percentage; and
   converting, by the primary node 202, the plurality of bearers of the plurality of UEs 208a, 208b . . . 208n to a plurality of split bearers when the plurality of UEs 208a, 208b . . . 208n connected to the cell associated with the plurality of SCG bearers exceeds the bearer conversion threshold percentage, wherein the plurality of split bearers distribute data between the primary node (202) and a secondary node 206.
[2] The method 700 as described in [1], wherein receiving the plurality of input parameters at the RIC 210 comprises:
   determining, by the RIC 210, whether the plurality of input parameters is available from the primary node 202;
   performing, by the RIC 210, one of:
   waiting for the plurality of input parameters from the primary node 202 upon determining that the plurality of input parameters is not available from the primary node 202.
[3]. The method 700 as described in any of [1]-[2], wherein the bearer conversion threshold percentage comprises a Multi-Radio Dual Connectivity (MRDC), wherein the MRDC comprises an Evolved-Universal Terrestrial Radio Access Network (E-UTRAN) New Radio (NR) Dual Connectivity (ENDC) bearer conversion threshold percentage, a New Radio Dual Connectivity (NR-DC) bearer conversion threshold percentage, and an NR E-UTRA Dual Connectivity (NE-DC) bearer conversion threshold percentage, wherein the bearer conversion threshold percentage indicates a predetermined limit of the plurality of UEs 208a, 208b . . . 208n for regulating conversion of bearer types between the primary node 202 and the secondary node (206).
[3]. The method 700 as described in any of [1]-[3], wherein the plurality of input parameters from the primary node 202 comprises at least one of a subscriber capacity, a cell bandwidth from configuration, and the cell bandwidth of the secondary node 206, wherein the cell bandwidth of the secondary node 206 is received during a connection establishment of the primary node 202 with the secondary node 206 connection.
[4]. The method 700 as described in any of [1]-[3], comprising:
   establishing, by the primary node 202, a Quality Class Identifier (QCI) between the plurality of UEs 208a, 208b . . . 208n and the primary node;
   configuring, from the primary node 202, a signal measurement for Secondary Node (SN) addition to the plurality of UEs 208a, 208b . . . 208n upon establishing the QCI; and
   receiving, at the primary node 202, a signal measurement report from the plurality of UEs 208a, 208b . . . 208n based on configuration.
[5]. The method 700 as described in any of [1]-[4], wherein converting the plurality of bearers of the plurality of UEs 208a, 208b . . . 208n to the plurality of SCG bearers comprises:
   assigning, by the primary node 202, as part of a Secondary Node (SN) addition, the plurality of bearers between the UE and the secondary node 206 as the plurality of SCG bearers; and
   transferring, data to the plurality of UEs 208a, 208b . . . 208n exclusively through the secondary node 206 upon assigning the plurality of bearers as the plurality of SCG bearers.
[6]. The method 700 as described in any of [1]-[5], wherein converting the plurality of bearers of the plurality of UEs 208a, 208b . . . 208n to the plurality of split bearers comprises:
   assigning, by the primary node 202, as part of a secondary node addition, the plurality of bearers between the plurality of UEs 208a, 208b . . .208n and the primary node 202 and between the primary node 202 and the secondary node 206 as the plurality of split bearers; and
   transferring, through the primary node 202 and the secondary node 206, the data to the plurality of UEs 208a, 208b . . . 208n upon assigning the plurality of bearers as the plurality of split bearers.
[7]. A method 800 comprising:
   receiving, at a Radio Access Network (RAN) Intelligent Controller (RIC) 210, a plurality of input parameters from primary node 202 and a secondary node 206;
   determining, by the RIC 210, a bearer conversion threshold percentage based on the received plurality of input parameters; and
   transmitting, by the RIC 210, the determined bearer conversion threshold percentage to the primary node 202.
[8]. The method 800 as described in [7], wherein receiving the plurality of input parameters at the RIC 210 comprises:
   determining, by the RIC 210, whether the plurality of input parameters is available from the primary node 202;
   performing, by the RIC 210, one of:
   waiting for the plurality of input parameters from the primary node 202 upon determining that the plurality of input parameters is not available from the primary node 202; or
   determining, by the RIC 210, whether an establishment of a connection with the secondary node 206 and RIC 210 upon determining that the plurality of input parameters is available from the primary node 202;
   performing, by the RIC 210, one of:
   not waiting for the plurality of input parameters from the secondary node upon determining that a non-establishment of the connection with the secondary node 206 from the RIC (210); or
   determining, by the RIC 210, whether the plurality of input parameters is available from the secondary node 206; and
   waiting for the plurality of input parameters from the secondary node (206) upon determining that the plurality of input parameters is not available from the secondary node 206.
[9]. The method 800 as described in any of [7]-[8], comprising:
   storing, by the RIC 210, the plurality of input parameters received from the primary node 202 and optionally from the secondary node 206.
[10]. The method 800 as described in any of [7]-[9], comprising:
   storing, by the RIC 210, the determined bearer conversion threshold percentage upon determining the bearer conversion threshold.
[11]. The method 800 as described in any of [7]-[10], wherein the plurality of input parameters from the primary node 202 comprises at least one of a subscriber capacity, a cell bandwidth from configuration, and the cell bandwidth of the secondary node 206, wherein the cell bandwidth of the secondary node 206 is received during a connection establishment of the primary node 202 with the secondary node 206.
[12]. The method 800 as described in any of [7]-[11], wherein the plurality of input parameters from the secondary node 206 comprises at least one of a subscriber capacity, a plurality of User Plane (UP) instances, throughput statistics, and the cell bandwidth.
[13]. The method 800 as described in any of [7]-[12], wherein the bearer conversion threshold percentage comprises an Evolved-Universal Terrestrial Radio Access Network (E-UTRAN) New Radio (NR) Dual Connectivity (E-UTRAN-DC) bearer conversion threshold percentage, a New Radio Dual Connectivity (NR-DC) bearer conversion threshold percentage, and an NR E-UTRA Dual Connectivity (NE-DC) bearer conversion threshold percentage.
[14]. The method 800 as described in any of [7]-[13], wherein the bearer conversion threshold percentage indicates a predetermined limit of the plurality of UEs 208a, 208b . . . 208n for regulating conversion of bearer types between the primary node 202 and the SgNB.
[15]. An apparatus 204, the apparatus 204 is configured to:
   transmit a plurality of input parameters to a Radio Access Network (RAN) Intelligent Controller (RIC) 210;
   receive a bearer conversion threshold percentage from the RIC 210;
      perform one of based on the received bearer conversion threshold percentage,
      convert a plurality of bearers of a plurality of User Equipments (UEs) 208a, 208b . . . 208n to a plurality of Secondary Cell Group (SCG) bearers when the plurality of UEs 208a, 208b . . . 208n connected to a cell associated with the plurality of bearers is below the bearer conversion threshold percentage; and
      convert the plurality of bearers of the plurality of UEs 208a, 208b . . . 208n to a plurality of split bearers when the plurality of UEs 208a, 208b . . . 208n connected to the cell associated with the plurality of SCG bearers exceeds the bearer conversion threshold percentage,
      wherein the plurality of split bearers distribute data between a primary node 202 and a secondary node 206.
[16]. The apparatus 204 as described in [15], wherein the bearer conversion threshold percentage comprises an Evolved-Universal Terrestrial Radio Access Network (E-UTRAN) New Radio (NR) Dual Connectivity (ENDC) bearer conversion threshold percentage, a New Radio Dual Connectivity (NR-DC) bearer conversion threshold percentage, and an NR E-UTRA Dual Connectivity (NE-DC) bearer conversion threshold percentage, wherein the bearer conversion threshold percentage indicates a predetermined limit of a plurality of User Equipments (UEs) 208a, 208b . . . 208n for regulating conversion of bearer types between the primary node 202 and the secondary node (206).
[17]. The apparatus 204 as described in any of [15]-[16], wherein the plurality of input parameters from the primary node 202 comprises at least one of subscriber capacity, cell bandwidth from configuration, and the cell bandwidth of the secondary node 206, wherein the cell bandwidth of the secondary node 206 is obtained during the establishment of the primary node 202 with the secondary node 206 connection.
[18]. The apparatus 204 as described in any of [15]-[17], wherein the primary node 202 is configured to:
   establish a Quality Class Identifier (QCI) between the plurality of UEs 208a, 208b . . . 208n and the primary node 202;
   configure a signal measurement for a Secondary Node (SN) addition to the plurality of UEs 208a, 208b . . . 208n upon establishing the QCI; and
   receive a measurement report from the plurality of UEs 208a, 208 b . . . 208n based on configuration.
[19]. The apparatus 204 as described in any of [15]-[18], wherein convert the plurality of bearers of the plurality of UEs 208a, 208b . . . 208n to the plurality of SCG bearers, the primary node 202 is configured to:
   assign the plurality of bearers as the plurality of SCG bearers between the plurality of UEs 208a, 208b . . . 208n and the primary node 202 and between the primary node (202) and the secondary node 206; and
   transfer data to the plurality of UEs 208a, 208b . . . 208n exclusively through the secondary node 206 upon assigning the plurality of bearers as the plurality of SCG bearers.
[20]. The apparatus 204 as described in any of [15]-[19], wherein converting the plurality of bearers of the plurality of UEs 208a, 208b . . . 208n to the plurality of split bearers, the primary node 202 is configured to:
   assign the plurality of bearers as the plurality of split bearers between the plurality of UEs 208a, 208b . . . 208n and the primary node 202 and between the primary node (202) and the secondary node 206;
   transfer, through the primary node 202 and the secondary node 206, the data to the plurality of UEs 208a, 208b . . . 208n upon assigning the plurality of bearers as the plurality of split bearers.

The embodiments disclosed herein can be implemented through at least one software program running on at least one hardware device and performing network management functions to control the elements. The elements can be at least one of a hardware device, or a combination of hardware devices and software modules.

It is understood that terms including “unit” or “module” at the end may refer to the unit for processing at least one function or operation and may be implemented in hardware, software, or a combination of hardware and software.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method comprising:
transmitting, by a primary node, a plurality of input parameters to a Radio Access Network (RAN) Intelligent Controller (RIC);
receiving, by the primary node, a bearer conversion threshold percentage from the RIC;
performing one of based on the received bearer conversion threshold percentage,
converting, by the primary node, a plurality of bearers of a plurality of User Equipments (UEs) to a plurality of Secondary Cell Group (SCG) bearers when the plurality of UEs connected to a cell associated with the plurality of bearers is below the bearer conversion threshold percentage; and
converting, by the primary node, the plurality of bearers of the plurality of UEs to a plurality of split bearers when the plurality of UEs connected to the cell associated with the plurality of SCG bearers exceeds the bearer conversion threshold percentage, wherein the plurality of split bearers distribute data between the primary node and a secondary node.

2. The method as claimed in claim 1, wherein the bearer conversion threshold percentage comprises a Multi-Radio Dual Connectivity (MRDC), wherein the MRDC comprises an Evolved-Universal Terrestrial Radio Access Network (E-UTRAN) New Radio (NR) Dual Connectivity (ENDC) bearer conversion threshold percentage, a New Radio Dual Connectivity (NR-DC) bearer conversion threshold percentage, and an NR E-UTRA Dual Connectivity (NE-DC) bearer conversion threshold percentage, wherein the bearer conversion threshold percentage indicates a predetermined limit of the plurality of UEs for regulating conversion of bearer types between the primary node and the secondary node.

3. The method as claimed in claim 1, wherein the plurality of input parameters from the primary node comprises at least one of a subscriber capacity, a cell bandwidth from configuration, and the cell bandwidth of the secondary node, wherein the cell bandwidth of the secondary node is received during a connection establishment of the primary node with the secondary node connection.

4. The method as claimed in claim 1, comprising:
establishing, by the primary node, a Quality Class Identifier (QCI) between the plurality of UEs and the primary node;
configuring, from the primary node, a signal measurement for Secondary Node (SN) addition to the plurality of UEs upon establishing the QCI; and
receiving, at the primary node, a signal measurement report from the plurality of UEs based on configuration.

5. The method as claimed in claim 1, wherein converting the plurality of bearers of the plurality of UEs to the plurality of SCG bearers comprises:
assigning, by the primary node, as part of a Secondary Node (SN) addition, the plurality of bearers between the UE and the secondary node as the plurality of SCG bearers; and
transferring, data to the plurality of UEs exclusively through the secondary node upon assigning the plurality of bearers as the plurality of SCG bearers.

6. The method as claimed in claim 1, wherein converting the plurality of bearers of the plurality of UEs to the plurality of split bearers comprises:
assigning, by the primary node, as part of a secondary node addition, the plurality of bearers between the plurality of UEs and the primary node and between the primary node and the secondary node as the plurality of split bearers; and
transferring, through the primary node and the secondary node, the data to the plurality of UEs upon assigning the plurality of bearers as the plurality of split bearers.

7. A method comprising:
receiving, at a Radio Access Network (RAN) Intelligent Controller (RIC), a plurality of input parameters from at least one of a primary node and a secondary node;
determining, by the RIC, a bearer conversion threshold percentage based on the received plurality of input parameters; and
transmitting, by the RIC, the determined bearer conversion threshold percentage to the primary node.

8. The method as claimed in claim 7, wherein receiving the plurality of input parameters at the RIC comprises:
determining, by the RIC, whether the plurality of input parameters is available from the primary node;
performing, by the RIC, one of:
waiting for the plurality of input parameters from the primary node upon determining that the plurality of input parameters is unavailable from the primary node; or
determining, by the RIC, whether an establishment of a connection with the secondary node and the RIC upon determining that the plurality of input parameters is available from the primary node;
performing, by the RIC, one of:
non-waiting for the plurality of input parameters from the secondary node upon determining that a non-establishment of the connection with the secondary node from the RIC; or
determining, by the RIC, whether the plurality of input parameters is available at the secondary node; and
waiting for the plurality of input parameters from the secondary node upon determining that the plurality of input parameters is unavailable from the secondary node.

9. The method as claimed in claim 7, comprising:
storing, by the RIC, the plurality of input parameters received from one of the primary node and the secondary node.

10. The method as claimed in claim 7, comprising:
storing, by the RIC, the determined bearer conversion threshold percentage upon determining the bearer conversion threshold.

11. The method as claimed in claim 7, wherein the plurality of input parameters from the primary node comprises at least one of a subscriber capacity, a cell bandwidth from configuration, and the cell bandwidth of the secondary node, wherein the cell bandwidth of the secondary node is received during a connection establishment of the primary node with the secondary node.

12. The method as claimed in claim 7, wherein the plurality of input parameters from the secondary node comprises at least one of a subscriber capacity, a plurality of User Plane (UP) instances, throughput statistics, and the cell bandwidth.

13. The method as claimed in claim 7, wherein the bearer conversion threshold percentage comprises a Multi-Radio Dual Connectivity (MRDC), wherein MRDC comprises an Evolved-Universal Terrestrial Radio Access Network (E-UTRAN) New Radio (NR) Dual Connectivity (ENDC) bearer conversion threshold percentage, a New Radio Dual Connectivity (NR-DC) bearer conversion threshold percentage, and an NR E-UTRA Dual Connectivity (NE-DC) bearer conversion threshold percentage.

14. The method as claimed in claim 7, wherein the bearer conversion threshold percentage indicates a predetermined limit of the plurality of UEs for regulating conversion of bearer types between the primary node and the SgNB.

15. An apparatus, the apparatus is configured to:
transmit a plurality of input parameters to a Radio Access Network (RAN) Intelligent Controller (RIC);
receive a bearer conversion threshold percentage from the RIC;
perform one of based on the received bearer conversion threshold percentage,
convert a plurality of bearers of a plurality of User Equipments (UEs) to a plurality of Secondary Cell Group (SCG) bearers when the plurality of UEs connected to a cell associated with the plurality of bearers is below the bearer conversion threshold percentage; and
convert the plurality of bearers of the plurality of UEs to a plurality of split bearers when the plurality of UEs connected to the cell associated with the plurality of SCG bearers exceeds the bearer conversion threshold percentage, wherein the plurality of split bearers distribute data between a primary node and a secondary node.

16. The apparatus as claimed in claim 15, wherein the bearer conversion threshold percentage comprises a Multi-Radio Dual Connectivity (MRDC), wherein MRDC comprises an Evolved-Universal Terrestrial Radio Access Network (E-UTRAN) New Radio (NR) Dual Connectivity (ENDC) bearer conversion threshold percentage, a New Radio Dual Connectivity (NR-DC) bearer conversion threshold percentage, and an NR E-UTRA Dual Connectivity (NE-DC) bearer conversion threshold percentage, wherein the bearer conversion threshold percentage indicates a predetermined limit of a plurality of User Equipments (UEs) for regulating conversion of bearer types between the primary node and the secondary node.

17. The apparatus as claimed in claim 15, wherein the plurality of input parameters from the primary node comprises at least one of subscriber capacity, cell bandwidth from configuration, and the cell bandwidth of the secondary node, wherein the cell bandwidth of the secondary node is obtained during the establishment of the primary node with the secondary node connection.

18. The apparatus as claimed in claim 15, wherein the primary node is configured to:
establish a Quality Class Identifier (QCI) between the plurality of UEs and the primary node;
configure a signal measurement for a Secondary Node (SN) addition to the plurality of UEs upon establishing the QCI; and
receive a measurement report from the plurality of UEs based on configuration.

19. The apparatus as claimed in claim 15, wherein convert the plurality of bearers of the plurality of UEs to the plurality of SCG bearers, the primary node is configured to:
assign the plurality of bearers as the plurality of SCG bearers between the plurality of UEs and the primary node and between the primary node and the secondary node; and
transfer data to the plurality of UEs exclusively through the secondary node upon assigning the plurality of bearers as the plurality of SCG bearers.

20. The apparatus as claimed in claim 15, wherein converting the plurality of bearers of the plurality of UEs to the plurality of split bearers, the primary node is configured to:
assign the plurality of bearers as the plurality of split bearers between the plurality of UEs and the primary node and between the primary node and the secondary node;
transfer, through the primary node and the secondary node, the data to the plurality of UEs upon assigning the plurality of bearers as the plurality of split bearers.
